(19) United States
(12) Patent Application Publication
(10) Pub. No.: US 2025/0132703 A1
(43) Pub. Date: Apr. 24, 2025

(54) METHOD FOR ROTATIONAL SPEED BUILD-UP AND ELECTRIC MOTOR

(71) Applicant: Schaeffler Technologies AG & Co. KG, Herzogenaurach (DE)

(72) Inventors: Erhard Hodrus, Achern (DE); Alexander Rösch, Achern (DE)

(73) Assignee: Schaeffler Technologies AG & Co. KG, Herzogenaurach (DE)

(21) Appl. No.: 18/834,660

(22) PCT Filed: Jan. 23, 2023
(86) PCT No.: PCT/DE2023/100046

§ 371 Date: Jul. 31, 2024

(30) Foreign Application Priority Data
Feb. 11, 2022 (DE) 10 2022 103 221.3

(51) Int. Cl. H02P 6/21

(52) U.S. Cl. CPC H02P 6/21

(57) ABSTRACT

A method for rotational speed build-up of an encoderlessly operated electric motor is disclosed that has a stator and a rotor that can be rotated at a rotational speed relative to said stator by changing a rotational position. The rotor is operated with electrical open-loop control in a first control step at least according to a target rotational position, and is operated with electrical closed-loop control in a subsequent second control step according to a calculated rotational position, which is dependent on the actual rotational position. The calculated rotational position is calculated as a reference rotational position in the first control step and a rotational position comparison is carried out at the beginning of the second control step at the latest, in which the target rotational position is compared with the reference rotational position and a starting rotational position is determined according to the rotational position comparison.

### CROSS-REFERENCE TO RELATED APPLICATIONS

This application is the U.S. National Phase of PCT Appln. No. PCT/DE2023/100046 filed Jan. 23, 2023, which claims priority to DE 10 2022 103 221.3 filed Feb. 11, 2022, the entire disclosures of which are incorporated by reference herein.

### TECHNICAL FIELD

The disclosure relates to a method for rotational speed build-. The disclosure further relates to an electric motor.

### BACKGROUND

WO 2020 001 681 A1 describes an electric motor with a stator and a rotor that can be rotated relative to the stator and a control system, which can output a current pulse to the electric motor, wherein the current pulse causes a rotational movement of the rotor in a first direction of rotation and by a first angle of rotation and thereby induces an induced voltage which is received by the control system and by which the control system determines the direction of rotation and/or the rotational position of the rotor with respect to the stator.

DE 10 2018 120 421 A1 discloses a method for encoderless control of permanently magnetically excited, synchronous electric motors, in which a system is described in a stationary αβ coordinate system of an electric motor. The system comprises an electromagnetic model and a mechanical model of an electric motor with drive train. For the model, differential inductances, each of which depends on the currents of the electric motor, are stored in the form of look-up tables. The look-up tables can be retrieved for calculation. Based on the electromagnetic and mechanical model, the rotational speed and angle of the electric motor are estimated by a Kalman filter, mainly via the mechanical model. The electrical model can be used to provide an internal torque for the torque equation in order to determine a change in rotational speed or angle.

### SUMMARY

The object of the present disclosure is to carry out a rotational speed build-up of the electric motor more efficiently and more quietly. Furthermore, the electric motor should be made more cost-effective and more reliable.

At least one of these objects is achieved by a method for rotational speed build-up having the features according to the claims and description provided herein. This allows the rotational speed build-up of the electric motor to be carried out more precisely and more quietly. The rotational position of the rotor can be measured more accurately. The use of injection signals during the start-up process of the rotor to determine the rotational position of the rotor and/or the rotor rotational speed may be omitted.

The electric motor can be arranged in a drive train of a vehicle. The drive train may be a hybrid drive train, preferably in a P1 configuration. The electric motor can provide drive power to propel the vehicle. The vehicle can be a motor vehicle.

Encoderless operation is understood to mean operation without taking into account a rotational position measured with a sensor, for example a position sensor.

The electric motor can be controlled via at least three motor phases.

By controlling the electric motor in the first control step via the target rotational position, the introduction of high-frequency injection voltages in the motor phases for detecting the rotational position can be omitted.

In the first control step, control of the electric motor may not occur depending on the calculated rotational position. In the first control step, the electric motor can only be operated in an open-loop controlled manner.

In the second control step, the electric motor can be operated in a closed-loop controlled manner dependent on an induced electromagnetic counter-field at the existing rotor rotational speed. In the second control step, the electric motor can be operated in a closed-loop controlled manner independently of the target rotational position.

In a preferred embodiment of the disclosure, it is advantageous if the starting rotational position at the beginning of the second control step is used as the calculated rotational position. This allows the electric motor to be operated in a controlled manner in the second control step, starting with the starting rotational position as the calculated rotational position, which may have been adjusted by the rotational position comparison.

A preferred embodiment of the disclosure is advantageous in which the starting rotational position is shifted by 180° relative to the reference rotational position by the rotational position comparison. This allows a correction of the reference rotational position and thus the starting rotational position. The starting rotational position may also correspond to the reference rotational position, preferably without such a correction.

In a preferred embodiment of the disclosure, it is advantageous if, during the rotational position comparison, a first difference is formed between the target rotational position present at a first time point and the reference rotational position at the first time point. The starting rotational position can be used as the calculated rotational position for the second control step depending on a verification result. The verification result may result from a check to see to what extent the first difference is constant over time. The inspection can provide an assessment of the accuracy of the starting rotational position. The inspection can be carried out before or at the beginning of the second control step.

In a preferred embodiment of the disclosure, it is advantageous if, during the rotational position comparison, a second difference is further formed between a reference rotational position shifted by 180° with respect to the reference rotational position present at the first time point and the target rotational position at the first time point. This makes it possible to detect a 180° shift that is undetected in the reference rotational position.

A preferred embodiment of the disclosure is advantageous in which the starting rotational position is calculated dependent on the first and second differences. The first and second differences can be compared.

In a preferred embodiment of the disclosure, it is provided that if an amount of the first difference is smaller than an amount of the second difference, the starting rotational position corresponds to the reference rotational position. In this case, a correction of the reference rotational position may not be necessary.

In a preferred embodiment of the disclosure, it is provided that if an amount of the second difference is smaller than an amount of the first difference, the starting rotational position corresponds to the reference rotational position shifted by 180°. This allows a correction of the reference rotational position.

A preferred embodiment of the disclosure is advantageous in which the first control step is carried out up to a rotational speed threshold of the rotational speed and the second control step is carried out when the rotational speed threshold is exceeded. The rotational speed threshold can be detected dependent on the motor speed of an internal combustion engine that is connected to the electric motor and rotates with it. The rotational position comparison can be carried out at a rotational speed that is below or equal to the rotational speed threshold. At the first time point, the rotational speed may be equal to the rotational speed threshold.

Furthermore, at least one of the above-mentioned objects is achieved by an electric motor having the features of the claims and description herein.

Further advantages and advantageous embodiments of the disclosure result from the description of the figures and the drawings.

### BRIEF DESCRIPTION OF THE DRAWINGS

The disclosure is described in detail below with reference to the drawings. In the figures:

FIG. 1: shows a method for rotational speed build-up in a particular embodiment of the disclosure.

FIG. 2: shows a temporal progression of a rotational position when carrying out the method of FIG. 1.

### DETAILED DESCRIPTION

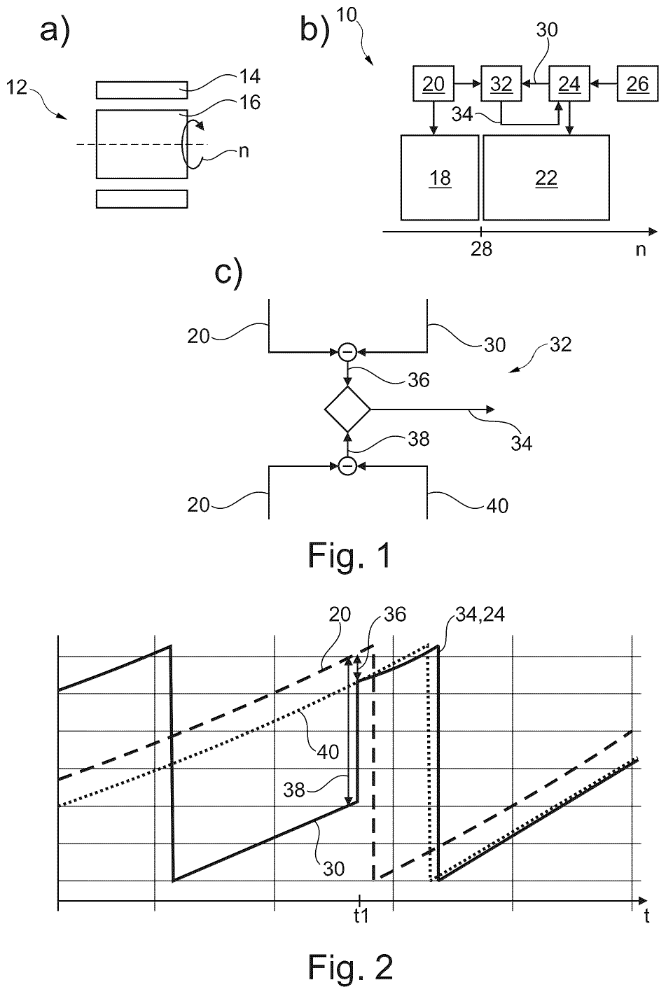

FIG. 1 shows a method for rotational speed build-up in a particular embodiment of the disclosure. The method for rotational speed build-up 10 of an electric motor 12 shown in FIG. 1 a) can be carried out for propelling a vehicle. The electric motor 12 can provide drive power to propel the vehicle. The electric motor 12 comprises a stator 14 and a rotor 16 that can be rotated at a rotor rotational speed n relative to said stator by changing a rotational position.

The method for rotational speed build-up 10 shown in FIG. 1 b) can be carried out starting from a non-rotating rotor 16 to increase the rotational speed n. Thus, the rotor 16 is operated with electrical open-loop control in a first control step 18 at least according to a target rotational position 20 of rotor 16, and is operated with electrical closed-loop control in a subsequent second control step 22 dependent on a calculated rotational position 24 of the rotor 16, which is dependent on the actual rotational position 26. The first control step 18 is executed up to a rotational speed threshold 28 of the rotational speed n and the second control step 22 is executed when the rotational speed threshold 28 is exceeded.

The calculated rotational position 24 is calculated as a reference rotational position 30 in the first control step 18 and a rotational position comparison 32 is carried out at the beginning of the second control step 22 at the latest, in which the target rotational position 20 is compared with the reference rotational position 30 and a starting rotational position 34 is determined dependent on the rotational position comparison 32. The starting rotational position 34 at the beginning of the second control step 22 is used as the calculated rotational position 24.

A first difference 36 is formed during the rotational position comparison 32 from the target rotational position 20 present at a first time point and the reference rotational position 30 at the first time point, as shown in FIG. 1 c). A second difference 38 is also formed during the rotational position comparison 32 from a reference rotational position 40, which is shifted by 180° relative to the reference rotational position 30 present at the first time point, and the target rotational position 20 at the first time point. The starting rotational position 34 is subsequently calculated dependent on the first and second difference 36, 38.

If an amount of the first difference 36 is smaller than an amount of the second difference 38, the starting rotational position 34 corresponds to the reference rotational position 30. If an amount of the second difference 38 is smaller than an amount of the first difference 36, the starting rotational position 34 corresponds to the reference rotational position 40 shifted by 180°.

FIG. 2 shows a temporal progression of a rotational position when carrying out the method of FIG. 1. The temporal progression of the target rotational position 20 is shown in comparison to the reference rotational position 30 and the reference rotational position 40 shifted by 180°. During the rotational position comparison, the target rotational position 20 is compared with the reference rotational position 30 and the shifted reference rotational position 30, 40. In this case, a first difference 36 is formed from the target rotational position 20 present at a first time point t1 and the reference rotational position 30 at the first time point t1, and a second difference 38 is formed from the target rotational position 20 present at the first time point t1 and the shifted reference rotational position 40.

Depending on the rotational position comparison, the starting rotational position 34, which is used as the calculated rotational position 24 in the second control step, is determined. Since an amount of the second difference 38 is smaller than an amount of the first difference 36, the starting rotational position 34 is assumed to correspond to the reference rotational position 40 shifted by 180° and thus a correction of the reference rotational position 30 is carried out.

### LIST OF REFERENCE SIGNS

10 Method for rotational speed build-up
12 Electric motor
14 Stator
16 Rotor
18 First control step
20 Target rotational position
22 Second control step
24 Calculated rotational position
26 Actual rotational position
28 Rotational speed threshold
30 Reference rotational position
32 Rotational position comparison
34 Starting rotational position
36 First difference
38 Second difference
40 Shifted reference rotational position
n Rotational speed
t1 First time point

1. A method for rotational speed build-up of an encoderlessly operated electric motor, comprising a stator and a rotor that can be rotated at a rotational speed relative to said stator by changing a rotational position, wherein:
operating the rotor with electrical open-loop control in a first control step at least according to a target rotational position, and
operating the rotor with electrical closed-loop control in a subsequent second control step dependent on a calculated rotational position, which is dependent on an actual rotational position, wherein the calculated rotational position is calculated as a reference rotational position in the first control step and a rotational position comparison is carried out at a beginning of the second control step at the latest, in which the target rotational position is compared with the reference rotational position and a starting rotational position is determined dependent on the rotational position comparison.

2. The method for rotational speed build-up according to claim 1, wherein the starting rotational position at the beginning of the second control step is used as the calculated rotational position.

3. The method for rotational speed build-up according to claim 1, wherein the starting rotational position is shifted by 180° in relation to the reference rotational position by the rotational position comparison.

4. The method for rotational speed build-up according to claim 1, wherein a first difference is formed during the rotational position comparison from the target rotational position present at a first time point and the reference rotational position at the first time point.

5. The method for rotational speed build-up according to claim 4, wherein a second difference is also formed during the rotational position comparison from a reference rotational position, which is shifted by 180° relative to the reference rotational position present at the first time point, and the target rotational position at the first time point.

6. The method for rotational speed build-up according to claim 4, wherein the starting rotational position is calculated dependent on the first and second difference.

7. The method for rotational speed build-up according to claim 6, wherein if an amount of the first difference is smaller than an amount of the second difference, the starting rotational position corresponds to the reference rotational position.

8. The method for rotational speed build-up according to claim 6, wherein if an amount of the second difference is smaller than an amount of the first difference, the starting rotational position corresponds to the reference rotational position shifted by 180°.

9. The method for rotational speed build-up according to claim 1, wherein the first control step is executed up to a rotational speed threshold of the rotational speed and the second control step is executed when the rotational speed threshold is exceeded.

10. An electric motor for encoderless operation and comprising a stator and a rotor that can be rotated at a rotational speed influenced by a method according to claim 1 relative to the stator by changing a rotational position.
